(19) United States
(12) Patent Application Publication
(10) Pub. No.: US 2023/0132662 A1
(43) Pub. Date: May 4, 2023

(54) METHANOTROPHIC BIO-BARRIERS FOR REDUCING METHANE EMISSIONS

(71) Applicant: Colorado State University Research Foundation, Fort Collins, CO (US)

(72) Inventors: Thomas Sale, Bellvue, CO (US); Kayvan Karimi Askarani, Fort Collins, CO (US); Joseph Scalia, Fort Collins, CO (US)

(73) Assignee: Colorado State University Research Foundation, Fort Collins, CO (US)

(21) Appl. No.: 18/052,353

(22) Filed: Nov. 3, 2022

Related U.S. Application Data
(60) Provisional application No. 63/275,374, filed on Nov. 3, 2021.

(51) Int. Cl. B01D 53/85; B01D 53/72

(52) U.S. Cl. CPC B01D 53/85; B01D 53/72; B01D 2257/7025

(57) ABSTRACT

A bio-barrier for reducing combustible gas emissions from the ground into the atmosphere is disclosed. The bio-barrier includes a geocomposite layer extending laterally beneath a top surface of the ground and a first geotextile layer extending laterally beneath the top surface of the ground and positioned above the geocomposite layer. The geocomposite layer and the geotextile layer configured to laterally disperse the combustible gas through at least the geotextile layer. In addition, at least one sensor may be positioned beneath the top surface of the ground and in or above the geocomposite layer, the at least one sensor measuring a parameter indicative of the concentration or oxidation of the combustible gas beneath the top surface of the ground.

### CROSS REFERENCE TO RELATED APPLICATION

This application claims priority from U.S. provisional Pat. application No. 63/275,374, titled “Methanotrophic Bio-Barriers for Reduced Methane Emissions,” filed on Nov. 3, 2021, the entirety of which is incorporated by reference herein.

### FIELD OF THE INVENTION

This application relates to devices, methods, and systems for reducing atmospheric methane (CH₄) and/or other stray gas emissions. In particular, this application relates to methanotrophic bio-barriers (MBB) for reducing atmospheric methane emissions from, for example, improperly abandoned/orphaned leaky oil and gas wells, landfills, and coal mines.

### BACKGROUND OF THE INVENTION

Globally, CH₄ is the second-largest emitted greenhouse gas in terms of volume behind carbon dioxide (CO₂), but is much more potent at trapping heat than CO₂. In 2018, 3.2 million abandoned oil and gas wells in the US were collectively responsible for emitting 281,000 kilotons of CH₄ into the atmosphere. These abandoned wells can also leak toxic substances (e.g., CH₄ or benzene) into surface groundwater.

In the abandoned wells, significant volumes of CH₄ can leak into the atmosphere and surface groundwaters through annular casing-to-casing interfaces and/or through casing-open hole wellbore-casing annuli. Current mitigation technique used to stop casing-to-casing annular leakage is to work over a well and install new cement plugs, cast iron bridge plugs, or mechanical devices at depth and/or within a surface casing string. These techniques are costly to implement and do not address leakage through casing-open hole wellbore-casing annuli. Thus, there is a need for more comprehensive and/or cost-effective mitigation techniques.

### SUMMARY OF THE INVENTION

In a first exemplary embodiment of the present invention a bio-barrier for reducing combustible gas emissions at a target site from the ground into the atmosphere is disclosed. The bio-barrier may include a geocomposite layer extending laterally beneath a top surface of the ground and a first geotextile layer extending laterally beneath the top surface of the ground and positioned above the geocomposite layer, the geocomposite layer and the geotextile layer may be configured to laterally disperse the combustible gas through at least the geotextile layer. In addition, the bio-barrier may include at least one sensor positioned beneath the top surface of the ground and within or above the geocomposite layer, the at least one sensor measuring a parameter indicative of the concentration or oxidation of the combustible gas beneath the top surface of the ground.

In some versions of the first exemplary embodiment, the geocomposite layer may be positioned between 1 and 20 feet beneath the top surface of the ground. The at least one sensor may include at least two laterally spaced sensors positioned at substantially the same level beneath the top surface of the ground. The at least one sensor may include at least two vertically spaced sensors at substantially the same horizontal position. The at least one sensor may include at least one of a temperature sensor, oxidation reduction potential sensor, pH sensor, or soil moisture sensor. The at least one sensor may include at least two different ones of a temperature sensor, oxidation reduction potential sensor, pH sensor, or soil moisture sensor. The bio-barrier may also include a second geotextile layer extending laterally beneath the top surface of the ground and positioned above and spaced apart from the first geotextile layer. The bio-barrier may include a sediment layer extending laterally beneath and directly contacting the geocomposite layer. The first geotextile layer may extend along a lateral edge of the geocomposite layer and may be configured to inhibit lateral dispersion of methane out of the geocomposite layer.

In a second exemplary embodiment of the present invention a bio-barrier for reducing stray gas emissions at a target site from the ground into the atmosphere is disclosed. The bio-barrier may include a geocomposite layer extending laterally beneath a top surface of the ground and a first geotextile layer extending laterally beneath the top surface of the ground and positioned above the geocomposite layer, the geocomposite layer and the geotextile layer configured to laterally disperse the stray gas through at least the geotextile layer. The bio-barrier may also include a first sediment layer extending laterally beneath and directly contacting the geocomposite layer.

In some versions of the second exemplary embodiment, the geocomposite layer may be positioned between 1 and 20 feet beneath the top surface of the ground. The first geotextile layer may extend along a lateral edge of the geocomposite layer and may be configured to inhibit lateral dispersion of the stray gas out of the geocomposite layer. The bio-barrier may also include a second geotextile layer extending laterally beneath the top surface of the ground and positioned above and spaced apart from the first geotextile layer. The bio-barrier may include a second sediment layer extending laterally between the first and second geotextile layers. The bio-barrier may also include a treatment layer above the top surface of the ground.

In a third exemplary embodiment of the present invention, a method for reducing combustible gas emissions at a target site from the ground into the atmosphere is disclosed. The method may include measuring the combustible gas emissions at a target site; calculating, based on the measured combustible gas emissions, a surface area of a bio-barrier to be installed at the target site; and installing the bio-barrier beneath the top surface of the ground at the target site. The bio-barrier may include a geocomposite layer extending laterally beneath the top surface of the ground and a first geotextile layer extending laterally beneath the top surface of the ground and positioned above the geocomposite layer, the geocomposite layer and the geotextile layer configured to laterally disperse the combustible gas through at least the geotextile layer.

In some versions of the third exemplary embodiment, the bio-barrier may include at least one sensor positioned beneath the top surface of the ground and within or above the geocomposite layer. The method may include measuring, with the at least one sensor, a parameter indicative of the concentration or oxidation of the combustible gas beneath the top surface of the ground. The method may also include calculating, based at least in part on the measured parameter indicative of the concentration or oxidation of the combustible gas, a quantity of the combustible gas emissions at the target site beneath the top surface of the ground. The bio-barrier may include a first sediment layer extending laterally beneath and directly contacting the geocomposite layer.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a conceptional block diagram showing an exemplary methanotrophic bio-barrier system installed about a leaking oil and gas well.

FIG. 2 is a conceptional block diagram showing another exemplary methanotrophic bio-barrier system.

FIG. 3 is schematic diagram illustrating a sensor array management system for collecting, managing, and transmitting sensor data received from a sensor array.

FIG. 4 is a diagram illustrating an example of a computing system which may be used in implementing embodiments of the present disclosure.

### DETAILED DESCRIPTION

Reference will now be made in detail to the exemplary embodiments, which are illustrated in the accompanying drawings. Wherever possible, the same reference numbers will be used throughout the drawings to refer to the same or like parts.

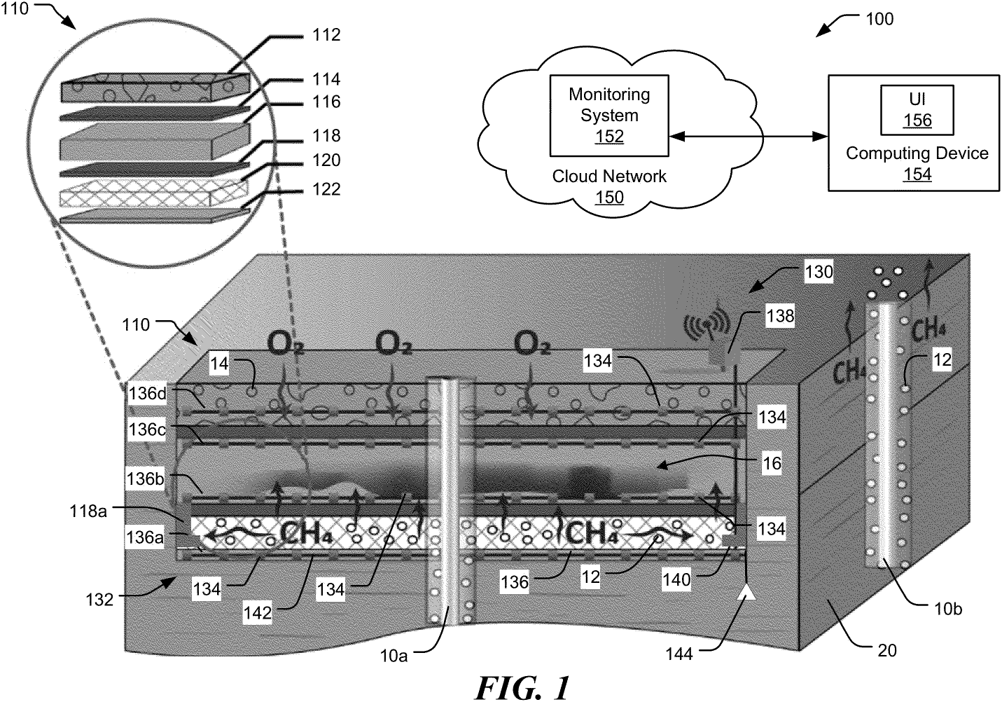

Described herein is a methanotrophic bio-barrier system and method for reducing combustible gas emissions, including hydrocarbon gasses, such as methane and/or other stray gas emissions. FIG. 1 shows an exemplary embodiment of a methanotrophic bio-barrier system 100 installed about a leaking well 10a to mitigate the release of methane (CH₄) 12 into the atmosphere and an unmitigated leaking well 10b for comparison. The leaking wells 10a and 10b may be oil or gas wells that emit methane 12 through, for example, casing-to-casing interface leakages or through casing-open hole leakages and then through the surrounding soil 20. Unmitigated methane 12 emissions generally flow vertically or along preferential pathways through the soil in close proximity to the leaking well 10b at a high flux into the atmosphere. Methanotrophs native to soil oxidize methane 12 into carbon dioxide and water, relying on oxygen (O₂) 14 presence in the soil to fuel this reaction. In the soil near a leaking well 10a or 10b, the concentration of methanotrophs and/or oxygen may not be high enough to mitigate the high flow rate of methane 12 resulting in a large upward net flux of methane 12. Although the example depicted in FIG. 1 shows leaking wells 10a and 10b as sources of methane 12 emissions, in other embodiments, landfills, coal mines, and the like may be the source of high methane fluxes.

A target site, such as leaking well 10a, may be identified and the methane and carbon dioxide flow rates may be monitored using multiple point dynamic chamber surveys (e.g., Li-Cor™), time-integrated gas discharge measurements using carbon dioxide or methane traps. Based on the measured methane flow rates, the surface area of an evacuation site and a methanotrophic bio-barrier (MBB) 110 to be installed may be calculated. For example, an approximate 1000 ft² surface area MBB 110 may be installed at a target site having 1 standard ft³/min emission of methane or other gas phase hydrocarbon. Subsequently, the soil at target site may be evacuated and the MBB 110 may be installed to laterally disperse the leaking methane 12 across the surface of the MBB 110 providing a smaller methane flux across the larger surface area than before. Due to the mitigated smaller methane flux, the methane 12 will react more completely with the methanotrophs and the oxygen in the soil reducing the methane emissions.

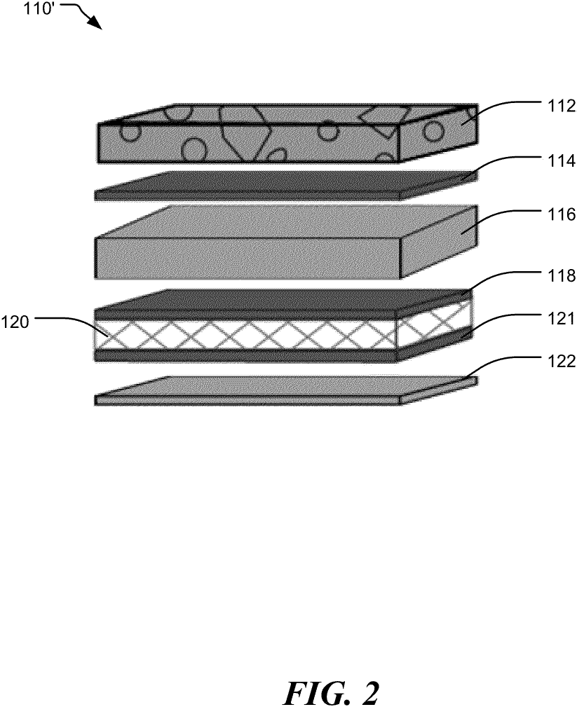

The methanotrophic bio-barrier system 100 may be comprised of a methanotrophic bio-barrier (MBB) 110 for mitigating methane emissions and a data acquisition system 130 for monitoring various parameters in the MBB 110 and the surrounding soil 20. FIG. 2 depicts another MBB 110', which includes the same layers of the MBB 110 with an additional layer and is discussed in more detail below. The methanotrophic bio-barrier system 100 may include either the MBB 110, MBB 110', or other MBBs within the scope of the present invention. Referring back to FIG. 1, the MBB 110 may be comprised of multiple layers, each extending generally horizontally and stacked vertically. FIG. 1 depicts the MBB 110 layers extending horizontally, but in other embodiments not shown, the MBB 110 layers may be sloped or irregular due to the topography of the target site or ground makeup, for example. The layers of the MBB 110 may comprise, for example, from the bottom to the top, a sediment layer, such as a first sand layer 122, a gas transmissive layer, such as a geocomposite 120, a first geotextile 118, a second sediment layer, such as a second sand layer 116, a second geotextile 114, and a structural cover 112.

The first sand layer 122 may be set directly on top of the cavity formed due to evacuating the soil at the target site to provide a stable foundation and a drainage pathway for accumulated water. Although sand is shown in FIG. 1, this first sand layer may also include a gravel or rock layer. The grain size for the sand and rock size for the gravel, along with the layer thickness may be determined based on environmental factors, such as anticipated rainfall and runoff. The geocomposite 120 and the first geotextile 118 may be positioned on top of the first sand layer 122. The geocomposite layer may be below the frost zone and deep enough to facilitate depletion of a large fraction of stray gases from the well. In some embodiments, the geocomposite layer may be positioned between 0.5 and 20 feet beneath the top surface of the ground. In some embodiments, the geocomposite layer may be positioned between 1 and 20 feet, 1 and 10 feet, or 2 and 5 feet beneath the top surface of the ground. Preferably, the geocomposite layer may be positioned between 2 and 4 feet beneath the top surface of the ground. In another embodiment of an MBB 110' shown in FIG. 2, an additional geotextile 121 may be positioned under the geocomposite 120, effectively, forming a bottom layer of the geocomposite 120. In such embodiment, the additional geotextile may have the same or similar composition of the first geotextile 118. The geocomposite 120 may be, for example, an oleophilic geocomposite having an open (conductive) woven fibrous structure, such as high density polyethylene. In one example, the geocomposite is a geonet. The first geotextile 118 may be, for example, non-woven pressed fibers, such as polypropylene. However, the first geocomposite 120 and the first geotextile 118 may be comprised of other materials that absorb petroleum hydrocarbons and permit bacterial colonization. In some embodiments, the geocomposite 120 may have a thickness of approximately 300 mil and the first geotextile 118 and additional geotextile may each have a thickness of approximately 25 mil. In some embodiments, the first geotextile 118 may have edge portions 118a that wrap around the edges of the geocomposite, laterally encasing it to prevent invasion of fine grain sediment and to limit the lateral diffusion of methane 12 away from the MBB 110. A suitable length of the first geotextile 118 may be folded over the outer edges of the geocomposite 120 and held by in place by the weight of the above layers alone, stapled together, or glued together. The geocomposite 120 and first geotextile 118 may help laterally disperse methane 12 through the geocomposite 120.

The second sand layer 116 may be set on top of the first geotextile 118. As with the first sand layer 122, the grain size and thickness for the second sand layer may be selected based on environmental factors. In one example, the second sand layer 116 may be approximately 3 inches thick. The second sand layer 116 may provide a medium for methanotrophs to react with the methane emissions, protect the first geotextile 118 and geocomposite 120, and limit downward invasion of fine-grained material, such as silt-sediment, into the first geotextile 118 geocomposite 120.

As depicted in FIG. 1, methane 12 from leaking well 10a travels upward through the soil 20 adjacent the leaking well 10a until it reaches the first geotextile 118, at which point it diffuses laterally and then upward through the geotextile 118 into the second sand layer 116. The methanotrophs in the second sand layer 116 facilitate the exothermic reaction between methane and electron acceptors (including oxygen) and generates heat 16, water, and carbon dioxide, i.e., CH₄ + O₂ ➔ CO₂ + 2H₂O . Methanotrophs include bacteria and archaea which oxidize methane as their source of carbon and chemical energy. Although FIG. 1 depicts heat being generated in the second sand layer 116, methane may react in any layer where methanotrophs are present including the geocomposite 120 and layers above the second sand layer 116. Any of these layers may have a native population of methanotrophs or inoculum may be introduced prior to installation and/or after installation via water transport.

The second geotextile 114 may be positioned on top of the second sand layer 116 to limit invasion of the structural cover 112 and other upper layers into the second sand layer 116. The structural cover 112 may be positioned on top of the second geotextile 114 to address erosion via ice scour, stream flow, wave action, and collisions. The structural cover 112 may include gravel, rocks, silt, and clay and have a thickness of 12 inches, for example. The structural cover 12 may extend flush with the top of nearby unevacuated soil or it may include a mound (not shown) of compacted soil or other treatment layers raised above the top of the nearby unevacuated soil. The mound may have a height on the order of inches or feet. The structural cover 112, with or without a mound, includes additional soil with additional methanotrophs to further reduce methane emissions.

In addition to environmental benefits, there may be economic incentives for reducing methane emissions. For example, lower methane emissions may help resolve carbon credits. Carbon credits are permits that allow a property owner/business to emit a predetermined amount of greenhouse gasses. Unused allowances may be sold and traded to another property owner/business. Thus, by not only reducing the methane emissions, but also measuring and recording the methane emissions, the methanotrophic bio-barrier system 100 may provide financial benefits as well.

Turning to the data acquisition system 130, FIG. 1 also illustrates a sensor array 132 disposed along a plurality of lateral transects 136 each comprising a horizontally disposed cable or cable portion 142 and intersecting or substantially intersecting the leaking well 10a. In the example depicted in FIG. 1, a first lateral transect 136a is located within the first sand layer 122, a second lateral transect 136b is located within a lower portion of the second sand layer 116 near the first geotextile 118, a third lateral transect 136c is located within an upper portion of the second sand layer 116 near the second geotextile 114, and a fourth lateral transect 136d is located within the structural cover 112. In other embodiments, more lateral transects may be positioned at various depths or fewer lateral transects may be used. The horizontal cable 142 may branch off from a vertically disposed cable or cable portion 140 that connects the sensor array 132 to a data acquisition component 138. The vertical cable 140 may be positioned near the leaking well 10a such that the lateral transects 136 would extend radially away from the leaking well 10a or, as shown, the lateral transects 136 may be positioned radially away from the leaking well 10a and extend across, substantially intersecting the leaking well 10a. In other embodiments, more than one lateral transects may extend at each depth, for example, additional lateral transects may extend at the same depths as the first, second, third, and fourth lateral transects 136a-136d, but along different lateral pathways angularly spaced apart from one another. In another embodiment not shown, vertical cables may extend downward at various horizontal positions from a horizontally oriented cable above ground or near ground level.

The sensor array 132 is disposed along the plurality of lateral transects 136 such that a plurality of sensor modules 134 are laterally spaced from each other along each lateral transect 136. In the embodiment shown, the spacing is substantially the same on each of the lateral transects 136a-136d, such that the sensor modules 134 are substantially vertically aligned with a corresponding sensor module 134 from each lateral transect 136a-136d. Each of the modules may be configured to measure aspects of the MBB 110, such as temperature, soil moisture, water levels, oxidation-reduction potential (ORP), pH, and the like. The sensor array 132 provides continuous, real-time monitoring of the target site through synergistic data sets that uniquely characterize the status of the MBB 110. Each sensor module 134 may contain multiple sensors, with each sensor being configured to obtain a measurement of a condition, characteristic, or aspect of the MBB 110. For example, a particular sensor module may include multiple sensors, such as a temperature sensor, an oxidation-reduction potential sensor, and a pH sensor. The sensors modules 134 may be receive power and communicate with the data acquisition component 138 via the horizontal and vertical cables 142, 140. Portions of the horizontal and vertical cables 142, 140 may be housed in a conduit for protection.

In some instances, each sensor of the sensor array 132 may be encased in a chemically resistant clear epoxy to protect each sensor from damage. The horizontal and vertical cables 142, 140 may include communication wires and/or sensor leads may further include a chemically resistant wire coating (such as Teflon) and may be housed within the conduit to protect the wires from physical and chemical damage. The conduit may include a vinyl tube coated with a chemically resistant material and, in some instances, a grout or other filling material may be injected into the interior of the conduit to further protect the communication wires within. Further, in some instances, one or more sensors at each sensor module 134 may be placed inside the conduit to limit direct contact between the sensors and chemicals in the monitored area. An additional benefit of locating sensors inside the conduit is to reduce the potential for sensor damage during installation or placement within the MBB. Other materials and designs are also contemplated for use with the sensor array 132 described herein.

One such measurement includes an ORP sensor that measures the oxidation-reduction potential of the ground water. ORP measurements generally include a working electrode, a counter or reference electrode, and a voltage measurement device. A preference is noted for high impedance voltage measurement devices. The working electrode for the ORP sensor may include a nonreactive electrode (such as an electrode composed of titanium mesh with iridium oxide coating). The working electrodes may be placed at a position where ORP measurements are to be made with the working electrode in direct contact with the monitored media. In the example shown in FIG. 1, each sensor module 134 may include working electrodes for ORP measurements that obtain measurements at the various positions within the MBB 110.

The sensor array 132 may also include a reference electrode 144 for use in ORP measurements. The reference electrode may include a fixed potential and multiple working electrodes may be compared to a single reference electrode 144. The reference electrode 144 may be placed in a location with electrical continuity between the working electrode and the reference electrode 144.

The sensor module may include a water level sensor that provides a measurement of subsurface groundwater level. Through various vertical and/or horizontal monitoring fences of the sensor array 132 that include water level sensors, a magnitude and direction of groundwater flow may be determined for the target site. In some instances, the water level sensors may be unvented pressure measurement devices to reduce potential errors in the measurements introduced by water condensation in vent lines. However, other types of water level sensors may also be used. For example, water level sensors may be unvented pressure transducers in environments in which the effect of barometric pressure changes may be common to all pressure measurements. Further, multiple water level sensors may be used and the results from which may be compared and contrasted to gain an understanding of an estimated subsurface water level.

The sensor module 134 may include a temperature sensor for measuring the temperature of the MBB at or near the location of the temperature sensor. In some instances, the temperature sensor may include a thermal couple or thermistor encased in a chemically resistant media (such as an epoxy) to prevent damages to the sensor by chemicals in the subsurface region 116 or corrosion by water. Further, a subsurface heating element (such as a heat trace wire or the like) may be collocated with the temperature sensor. Pulse heating and measurement of temperatures may be used to acquire thermal properties of the monitored media.

The sensor module 134 may include a pH sensor for measuring the pH levels in the MBB. In some instances, the pH sensor may an antimony electrode and the reference electrode 144 or the pH sensor may use a pH sensitive transistor for detecting changes in pH.

Additional or fewer sensors may also be included in the sensor array 132. For example, the sensor array 132 may include additional sensor modules or sensors connected to the horizontal cable 142 in a similar manner as the illustrated sensor modules 134. Further, the order of the sensors of the sensor group may vary from sensor module 134 to sensor module 134 along the sensor array 132. Also, the reference electrode 144 may be located at any position along the sensor array 132 for use in reference for ORP or pH measurements. The sensor array 132 may therefore include various configurations of sensors and sensor locations to provide measurements of the MBB 110 at various locations. Further still, one or more above-surface sensors may be included on and/or incorporated with the sensor array 132. For example, a barometric sensor may be included in the sensor array 132 near or on the data acquisition component 138 for measuring the atmospheric pressure at the target site. Other environmental or meteorological sensors may also be included located at the surface of the target site and in communication with the data acquisition component 138.

As mentioned above, the sensors of the sensor array 132 provide measurement signals, data, and/or information of the target site to the data acquisition component 138. The sensor information may be provided to the data acquisition component 138 via the horizontal and vertical cables 142 and 144 contained within the conduit. The data acquisition component 138 may receive and process the provided data and information from the sensors of the sensor array 132 and, in some instances, provide the data to a centralized monitoring system 152 through a wired or wireless connection. The monitoring system 152 may be implemented in a cloud computing environment 150 or other network environment. The data acquisition component 138 may therefore be configured to communicate with the cloud network 150 for transmission of the sensor data to the monitoring system 152. As explained in more detail below, the monitoring system 152 may process and provide the received data to one or more computing system for display on one or more display devices. In this manner, the data acquisition component 138 may provide the measured data of the target site for analysis by a site monitor or administrator.

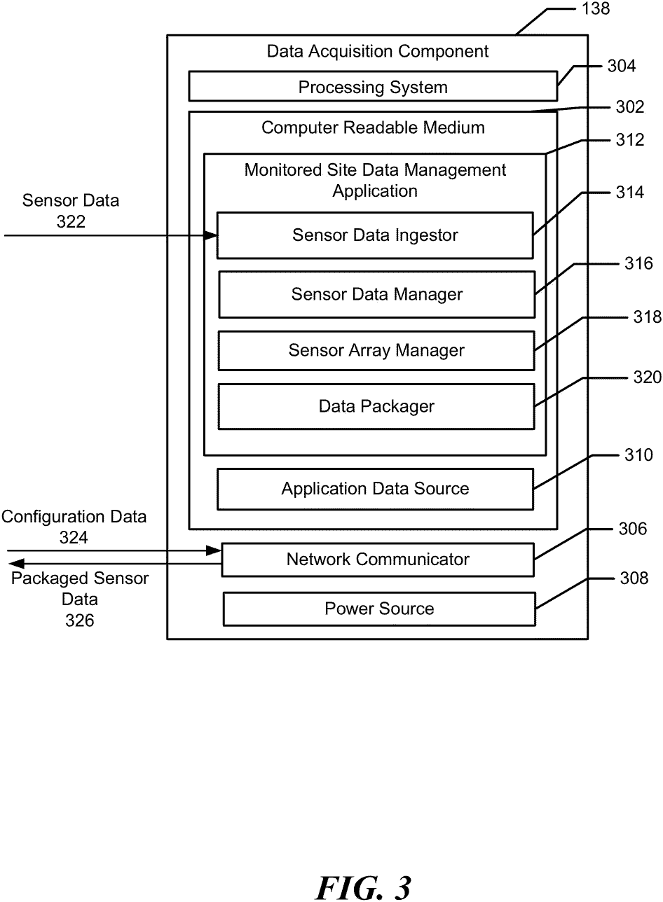

FIG. 3 is a schematic diagram illustrating the data acquisition component 138 for collecting, managing, and transmitting sensor data received from a sensor array 132 described above. In some instances, a monitored site data management application 312 may be executed on the data acquisition component 138 to perform one or more of the operations described herein. The monitored site data management application 312 may be stored in a computer readable media 302 (e.g., memory) and executed on a processing system 304 of the data acquisition component 138 or other type of computing system, such as that described below. For example, the monitored site data management application 312 may include instructions that may be executed in an operating system environment, such as a Microsoft Windows™ operating system, a Linux operating system, or a UNIX operating system environment. The computer readable medium 302 includes volatile media, nonvolatile media, removable media, non-removable media, and/or another available medium. By way of example and not limitation, non-transitory computer readable medium 302 comprises computer storage media, such as non-transient storage memory, volatile media, nonvolatile media, removable media, and/or non-removable media implemented in a method or technology for storage of information, such as computer readable instructions, data structures, program modules, or other data.

According to one instance, the data acquisition component 138 may also include a network communicator 306 for communicating with the network 150 and/or the monitoring system 152. In one example, the network communicator 306 may include wireless communication devices for transmitting a wireless communication signal to the network 150. The network communicator 306 may utilize any known or hereafter developed wireless communication protocol, such as cellular, satellite, Bluetooth, WiFi, or any other wireless system. The network communicator 306 may therefore include many types of transmitters, such as antennas, directional antennas, satellite dishes, and the like. The data acquisition component 138 may also include a power source to provide operational power to the components of the data acquisition component 138. In some instances, the power source 308 may include batteries, solar cells, one or more plugs for connection to a power grid, and the like. The network communicator 306 and/or the power source 308 may also be configured to provide status information or data to the monitored site data management application 312. Such information may be transmitted to the monitoring system 152 as operational status information of the data acquisition component 138.

The data management application 312 may utilize an application data source 310 of the computer readable media 302 for storage of data and information associated with the data acquisition component 138. For example, the data management application 312 may store information associated with the sensor array 132 and/or the target site in general, including data and information received from the sensors and sensor modules 134 of the data array 132, information unique to the target site (such as an identifier of the target site, address information of the sensors of the sensor array 132, and operational status information of the components of the data acquisition component 138 and/or the sensors and sensor modules 134 of the sensor array 132), and the like. In general, any data or information utilized by the data management application 312 may be stored and/or retrieved via the data source 308.

The data management application 312 may include several modules or programs to perform one or more of the operations described herein. For example, a sensor data ingestor 314 may be included in the data management application 312 to receive data and information 322 from one or more sensors of the sensor array 132. For example, sensor data 322 may be transmitted from the sensors of the sensor array 132 via the horizontal and vertical cables 136, 140 to the sensor data ingestor 314. The sensor data ingestor 314 may store the received sensor data 322 in the application data source 310, in some instances. Further, the data management application 312 may include a sensor data manager 316 configured to process the received sensor data 322. In one example, packets of the received sensor data 322 may be addressed with a corresponding sensor identifier to indicate which sensor of the array 132 provides the sensor information. The sensor data manager 316 may extract or analyze the address associated with a packet of data of the sensor data 322 to determine which sensor transmits the data packet. The sensor data manager 316 may also associate the sensor identifier in the application data source with the corresponding sensor data. In the instance where the sensor array 132 includes multiple wires within the multiple horizontal cables 136, the sensor data manager 316 may determine the communication wire from which information or data is received and store the sensor data 322 with an indication of the sensor group from which the sensor data 322 was received. In general, the sensor data manager 316 organizes the received sensor data 322 based on sensor location within the sensor array 132 and the target site 102 for use by the monitoring system 152, as is discussed in more detail below.

The data management application 312 may also include a sensor array manager 318 configured to manage operational states of the sensor array 132. For example, the sensor array manager 318 may generate and assign unique addresses to the various sensors of the sensor array 132. The sensor array manager 318 may also receive data or information from the sensors of the array 132 that indicate an operational status of the sensors and, in response to the received information, store the operational status of the sensors in the application data source 310. The sensor data manager 318 may communicate with the sensor array manager 318 to determine the particular sensors of the array 132 from which sensor data 322 is received.

In another example, sensor array manager 318 and/or sensor data manager 316 may control aspects of the sensor data 322 collection. For example, sensors of the sensor array 132 may obtain sensor measurements or readings in response to a request or activation signal transmitted to the sensors 112 via a communication wire in the horizontal and vertical cables 142, 140. In this manner, the communication wire may be bi-directional to provide both upstream and downstream communications. The commands or requests to obtain a measurement and provide said measurement to the data acquisition component 138 may be addressed in a similar manner as described above such that particular sensors may receive the request. In some instances, the sensor data manager 316 and/or the sensor array manager 318 may be configured to determine a time to request site measurements from the sensors, generate the requests, and transmit the requests on the communication wire. The request for sensor data 322 may occur at a regular frequency, such as every 30 minutes, every hour, every day, etc. The frequency at which requests for sensor information 322 is requested may be provided by the monitoring system 152, as described in more detail below. In another example, the data management application 312 may include artificial intelligence processes to determine the frequency of data collection and adjust the sensor data manager 316 and/or sensor array manager 318 accordingly.

A data packager 320 may also be included in the data management application 312. The data packager 320 may be configured to receive the sensor data 322 from the sensor data manager 316 or from the application data source 310 and package the sensor data 322 for transmission to the monitoring system 152. Packaging the sensor data 322 may include collecting data from the same sensor into a package, addressing data packets with an address associated with the monitoring system 152, discarding erroneous sensor data 322, collecting sensor data based on date/time of collection, and the like. The data packager 320 (or other component of the data management application 312) may utilize the network communicator 306 for transmitting the packaged sensor data 326 to the monitoring system 152. As such, the data packager 320 may generally prepare the sensor data 322 and/or sensor array information for transmission to the monitoring system 152 via the network communicator 306.

In addition, the network communicator 306 may receive sensor array configuration data 324 from the monitoring system 152 or from another computing device. Thus, the data management application may be accessible through a wired or wireless communication for providing the configuration data 324. The sensor array manager 318 may utilize the configuration data 324 to configure one or more aspects of the sensor array 132. For example, the sensor array manager 318 may adjust the frequency at which sensor data 322 is requested or stored in response to the configuration data 324. In another example, the addressing scheme utilized by the sensor array 132 may be configured to include more or fewer sensors based on the configuration data 324. Other aspects of the data management application 312 may also be configured or altered based on the configuration data 324. In this manner, the sensor array 132 deployed at the target site may be remotely configured via the configuration data 324 transmitted to the data acquisition component 138.

It should be appreciated that the components described herein are provided only as examples, and that the application 312 may have different components or programs, additional components or programs, or fewer components or programs than those described herein. For example, one or more components or programs as described in reference to and shown in FIG. 3 may be combined into a single component or program. As another example, certain components or programs described herein may be encoded on, and executed on other computing systems, such as on one remotely coupled to the data acquisition component 138.

Through the sensor array 132 described herein, conditions at the target site 102 may be determined remotely. Further, the measurements of conditions at the target site may be processed by a monitoring system 152 for display to a remotely located monitoring party. Continuous, real-time monitoring of temperature, water levels, ORP, and pH of the target site provides advantages for monitoring the site over other types of site measurements. In particular, the display and consideration of a combination of measured temperature, water levels, ORP, and pH of the MBB 110 of the target site provide a beneficial snapshot of the conditions of the site.

As mentioned above, the monitoring system 152 may receive sensor data 322 from a data acquisition component 138 of a sensor array 132 deployed at a target site. In some instances, the monitoring system 152 may process the received sensor data 322 and provide a dashboard or other user interface through which the sensor data 322 may be displayed or viewed by a user of the monitoring system 152. More particularly, a user may utilize a computing device 154, such as a smart phone, laptop computer, desktop computer, or any other computing device 154 configured to communicate with cloud network 150, to access the monitoring system 152 and view the sensor data 322 obtained by the sensor array 132. In one instance, the computing device 154 may execute a user interface 156 to provide access to the monitoring system 152 and the sensor data 322 managed by the monitoring system 152. In this manner, a user of the computing device 154 may monitor the conditions of the target site remotely via the monitoring system 152, removing the need to visit the target site to collect the subsurface samples. In addition, the monitoring system 152 may combine, alter, or otherwise process the sensor data 322 for display via the user interface 156 for ease of understanding by the user of the computing device 154.

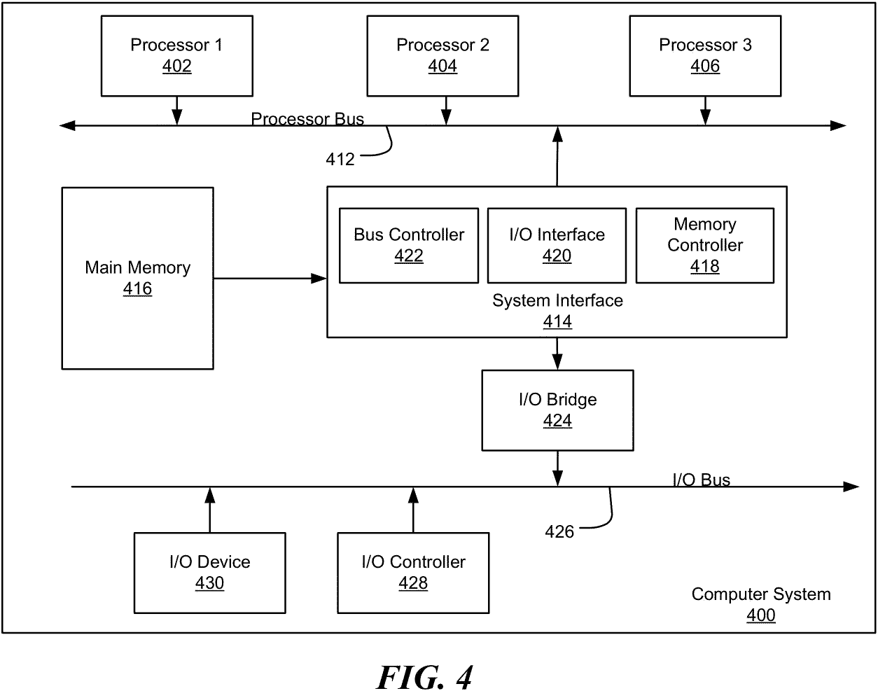

FIG. 4 is a block diagram illustrating an example of a computing device or computer system 400 which may be used in implementing the embodiments of the methanotrophic bio-barrier system 100 disclosed above. For example, the computing system 400 of FIG. 4 may be the monitoring system 152 discussed above. The computer system (system) includes one or more processors 402-406. Processors 402-406 may include one or more internal levels of cache (not shown) and a bus controller or bus interface unit to direct interaction with the processor bus 412. Processor bus 412, also known as the host bus or the front side bus, may be used to couple the processors 402-406 with the system interface 414. System interface 414 may be connected to the processor bus 412 to interface other components of the system 400 with the processor bus 412. For example, system interface 414 may include a memory controller 414 for interfacing a main memory 416 with the processor bus 412. The main memory 416 typically includes one or more memory cards and a control circuit (not shown). System interface 414 may also include an input/output (I/O) interface 420 to interface one or more I/O bridges or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system set forth in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. One or more memory devices may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

It should be understood from the foregoing that, while particular aspects have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A bio-barrier for reducing combustible gas emissions at a target site from the ground into the atmosphere, the bio-barrier comprising:
a geocomposite layer extending laterally beneath a top surface of the ground;
a first geotextile layer extending laterally beneath the top surface of the ground and positioned above the geocomposite layer, the geocomposite layer and the geotextile layer configured to laterally disperse the combustible gas through at least the geotextile layer; and
at least one sensor positioned beneath the top surface of the ground and within or above the geocomposite layer, the at least one sensor measuring a parameter indicative of the concentration or oxidation of the combustible gas beneath the top surface of the ground.

2. The bio-barrier of claim 1, wherein the geocomposite layer is positioned between 1 and 20 feet beneath the top surface of the ground.

3. The bio-barrier of claim 1, wherein the at least one sensor includes at least two laterally spaced sensors positioned at substantially the same level beneath the top surface of the ground.

4. The bio-barrier of claim 1, wherein the at least one sensor includes at least two vertically spaced sensors at substantially the same horizontal position.

5. The bio-barrier of claim 1, wherein the at least one sensor includes at least one of a temperature sensor, oxidation reduction potential sensor, pH sensor, or soil moisture sensor.

6. The bio-barrier of claim 1, wherein the at least one sensor includes at least two different ones of a temperature sensor, oxidation reduction potential sensor, pH sensor, or soil moisture sensor.

7. The bio-barrier of claim 1, further comprising a second geotextile layer extending laterally beneath the top surface of the ground and positioned above and spaced apart from the first geotextile layer.

8. The bio-barrier of claim 1, further comprising a sediment layer extending laterally beneath and directly contacting the geocomposite layer.

9. The bio-barrier of claim 1, wherein the first geotextile layer extends along a lateral edge of the geocomposite layer and is configured to inhibit lateral dispersion of the combustible gas out of the geocomposite layer.

10. A bio-barrier for reducing stray gas emissions at a target site from the ground into the atmosphere, the bio-barrier comprising:
a geocomposite layer extending laterally beneath a top surface of the ground;
a first geotextile layer extending laterally beneath the top surface of the ground and positioned above the geocomposite layer, the geocomposite layer and the geotextile layer configured to laterally disperse the stray gas through at least the geotextile layer; and
a first sediment layer extending laterally beneath and directly contacting the geocomposite layer.

11. The bio-barrier of claim 10, wherein the geocomposite layer is positioned between 1 and 20 feet beneath the top surface of the ground.

12. The bio-barrier of claim 10, wherein the first geotextile layer extends along a lateral edge of the geocomposite layer and is configured to inhibit lateral dispersion of the stray gas out of the geocomposite layer.

13. The bio-barrier of claim 10, further comprising a second geotextile layer extending laterally beneath the top surface of the ground and positioned above and spaced apart from the first geotextile layer.

14. The bio-barrier of claim 10, further comprising a second sediment layer extending laterally between the first and second geotextile layers.

15. The bio-barrier of claim 10, further comprising a treatment layer above the top surface of the ground.

16. A method for reducing combustible gas emissions at a target site from the ground into the atmosphere, the method comprising:
measuring combustible gas emissions at a target site;
calculating, based on the measured combustible gas emissions, a surface area of a bio-barrier to be installed at the target site; and
installing the bio-barrier beneath the top surface of the ground at the target site;
wherein the bio-barrier comprises:
a geocomposite layer extending laterally beneath the top surface of the ground; and
a first geotextile layer extending laterally beneath the top surface of the ground and positioned above the geocomposite layer, the geocomposite layer and the geotextile layer configured to laterally disperse the combustible gas through at least the geotextile layer.

17. The method of claim 16, wherein the bio-barrier further comprises at least one sensor positioned beneath the top surface of the ground and within or above the geocomposite layer, and the method further comprises:
measuring, with the at least one sensor, a parameter indicative of the concentration or oxidation of the combustible gas beneath the top surface of the ground.

18. The method of claim 17, further comprising calculating, based at least in part on the measured parameter indicative of the concentration or oxidation of the combustible gas, a quantity of the combustible gas emissions at the target site.

19. The method of claim 16, wherein the bio-barrier comprises a first sediment layer extending laterally beneath and directly contacting the geocomposite layer.

20. The method of claim 16, wherein the first geotextile layer extends along a lateral edge of the geocomposite layer and is configured to inhibit lateral dispersion of the combustible gas out of the geocomposite layer.

21. The method of claim 16, wherein the geocomposite layer is installed between 1 and 20 feet beneath the top surface of the ground.
